(19) United States
(12) Patent Application Publication
(10) Pub. No.: US 2008/0007717 A1
(43) Pub. Date: Jan. 10, 2008

(54) Noise Reduction Of Laser Ultrasound Detection System

(75) Inventors: Steen Arnfred Nielsen, Jyllinge (DK); Anne Marie Thommesen, Frederiksberg (DK); Bjarne Stenum, Copenhagen N (DK)

Correspondence Address: DAY PITNEY LLP, 7 TIMES SQUARE, NEW YORK, NY, 10036-7311, US

(73) Assignee: FORCE TECHNOLOGY, Brondby (DK)

(21) Appl. No.: 10/594,539

(22) PCT Filed: Mar. 31, 2005
(86) PCT No.: PCT/DK05/00221

§ 371 Date: Jan. 9, 2007

(30) Foreign Application Priority Data
Mar. 31, 2004 (DK) PA 200400512

(51) Int. Cl. G01N 21/00

(52) U.S. Cl. 356/73

(57) ABSTRACT

A method of detecting a property of an object comprising directing a detection laser beam to the object to produce a scattered laser beam modulated corresponding to a motion of said object; receiving the scattered laser beam with an optical interferometer to produce an interferometric transmission signal and an interferometric reflection signal; combining the transmission signal and the reflection signal to generate an output signal corresponding to the motion of the object. In one embodiment the method comprises scaling at least one of the reflection signal and the transmission signal relative to the corresponding other signal by a predetermined relative scale factor; and combining the scaled reflection and transmission signals with one another to obtain the output signal. In another embodiment, the combining comprises generating the output signal as a ratio of a signal derived from the transmission signal and a signal derived from the reflection signal.

This invention relates to interferometric detection devices and the detection of a property of an object by such a device. In particular, the invention relates to the detection of ultrasound in an object by means of a laser beam.

The ultrasonic inspection of materials, structures, objects, and the like, by means of a laser beam is an attractive technique, because it provides a non-destructive inspection method. In particular ultrasound inspection has proven useful for the detection of defects in materials such as metals, since the ultrasound pulses interact with such defects causing a modification of the detected ultrasound pulses.

In numerous applications laser-based ultrasound inspection has proven to be particularly advantageous, because it does not require physical contact between the object to be inspected and the ultrasonic sensor. Therefore, this technique is also well suited for applications where the object under inspection is moving, has a complex geometry, is sensitive to physical contact, has a high temperature, or the like.

Laser-based ultrasound detection is based on the fact that ultrasound pulses induced by an excitation laser and propagating within and along the surface of an object can be detected by directing a continuous-wave or long-pulse detection laser beam to the surface of the object and by detecting the reflected laser beam by an optical interferometer. Vibrations of the surface due to the ultrasound pulses cause a Doppler shift of the reflected laser beam compared to the incoming detection beam. Hence, the ultrasound pulses can be detected by demodulating the Doppler shift in the optical interferometer.

Generally, the excitation laser is a high-power short-pulse laser that produces ultrasound waves by surface stresses induced by laser absorption or by a recoil effect following surface ablation.

For example, the article “Laser ultrasonic detection of rail defects” by Shi-Chang Wooh et al., in Review of Quantitative Nondestructive Evaluation, Vol. 21, ed. By D. O. Thompson et al., pp. 1819-1826, American Institute of Physics, 2002, discloses a method of characterising rail defects using a laser ultrasonic scanning technique and by analysing shadow patterns produced by shear waves.

U.S. Pat. No. 4,659,224 describes a laser ultrasound detection device wherein a confocal Fabry-Perot interferometer is used.

It is generally desirable in connection with laser ultrasound detection to improve the signal-to-noise ratio. One source of signal noise is a variation of the intensity of the reflected laser beam. Such variations may e.g. be caused by instabilities of the detection laser, by variations in the reflectivity of the surface of the object during the inspection, or when inspecting moving objects. In fact, intensity variations of the reflected laser beam are a major source of noise when scanning a surface at high speeds.

In U.S. Pat. No. 5,080,491 a laser ultrasound system is described that utilises two substantially identical Fabry-Perot interferometers. A Fabry-Perot interferometer comprises a cavity defined by a front reflector/mirror through which the received light enters and a rear reflector/mirror. An output signal may be derived from either of the reflectors corresponding to the operation of the interferometer in transmission or reflection mode. The distance between the reflectors determines the resonance frequency of the interferometer. In the above prior art system, the outputs of the two interferometers are combined and the combined signal is used to control the length of the Fabry-Perot cavities. Even though this system provides a reduction of intensity fluctuations of the received light, it is a problem of the above prior art that two Fabry-Perot interferometers are required, thereby increasing the complexity and production costs, in particular because the above prior art system requires that the two interferometers are substantially identical.

The article “A conjugate optical confocal Fabry-Perot interferometer for enhanced ultrasound detection”, by Q Shan et al., Maes. Sci. Technol., 6 (July 1995), p. 921-928 describes a detection scheme wherein output signals of the Fabry-Perot interferometer from optical back reflection as well as from optical transmission are used to generate a conjugate signal.

U.S. Pat. No. 6,633,384 discloses a system for detecting ultrasonic displacements. This prior art system includes an interferometer that employs a differential signalling scheme to generate the output signal. The cavity length of the interferometer is adjusted such that the ratio of the transmission signal and the sum of the transmission and reflection signals is kept constant.

U.S. Pat. No. 5,137,361 discloses a system for detecting a surface motion of an object. The system includes an optical interferometer that is stabilised based on a signal generated as a ratio of the transmission signal and the input signal of the interferometer.

Even though the above prior art systems provide an improved signal-to-noise ratio for constant intensity of the reflected laser beam, it remains a problem to further reduce the signal-to-noise ratio due to variations in the intensity of the reflected laser beam, in particular in situations where the intensity of the reflected laser beam varies substantially. For example, such strong intensity variations of the laser beam that serves as an input to the interferometer occur when an object, in particular a metal object, is inspected by scanning the surface of the object at a high scanning speed, i.e. when the noise is caused by variations of the scanned surface.

According to a first aspect of the invention, the above and other problems are solved by a method of detecting a property of an object, the method comprising
directing a detection laser beam to the object to produce a scattered laser beam modulated corresponding to a surface motion of said object;
receiving the scattered laser beam with an optical interferometer to produce an interferometric transmission signal and an interferometric reflection signal corresponding to the surface motion of the object;
generating an output signal from the interferometric transmission signal and the interferometric reflection signal, the output signal being indicative of said surface motion;
characterised in that the output signal is generated as a ratio of a signal derived from the interferometrc transmission signal and a signal derived from the interferometric reflection signal.

It has been realised by the inventors that utilising the ratio of the transmission and reflection signals—or of signals derived from the transmission and reflection signals—as an output signal from the detection system provides an output signal that is indicative of ultrasonic surface displacements of the object. In particular, it has turned out that the ratio signal provides a high signal-to-noise ratio at high scanning speeds, i.e. in the presence of noise caused by variations in the light intensity due to surface variations. Hence, embodiments of the invention provide a laser ultrasound inspection method that allows the scanning of large surfaces at relatively high speeds. This is particularly advantageous when scanning e.g. rails, pipelines, or the like.

Furthermore, it is an advantage of the invention that it provides an inspection method that is not sensitive with respect to tuning parameters. Hence, low-noise detection results are obtained even for non-optimal choices of tuning parameters.

It is a further advantage that the method provides an output signal with an amplitude that does not depend on the intensity of the input signal. In particular, this is an advantage for certain subsequent signal processing/analysis methods.

In one embodiment, the ratio of the signal derived from the interferometric transmission signal and the signal derived from the interferometric reflection signal is the ratio of the interferometric transmission signal and the interferometric reflection signal, i.e. the ratio is directly determined from the transmission and the reflection signal. Hence, in this embodiment, the output signal does not rely on any additional tuneable parameters.

Since the input signal may vary between zero and the output intensity of the detection laser, the calculation of the ratio may involve a division with small numbers. In particular, when inspecting moving objects by a laser-ultrasound inspection system as described herein, the intensity of the reflected light may vary considerably. For example, when inspecting metallic objects such as railway tracks, the surface may be generally highly reflecting but with occasional dark spots due to corrosion, dirt, or the like, where the reflected intensity is drastically reduced or even vanishes. In particular, such small input signals may cause a problem when analogue multipliers are used, since these are typically slow when dividing by small signals. Furthermore, divider circuits or functions may become unstable when dividing by very small signals.

In one embodiment, this problem is solved when the method further comprises
generating a derived reflection signal from the interferometric reflection signal by adding a first offset to the interferometric reflection signal; and
generating a derived transmission signal from the interferometric transmission signal by adding a second offset to the interferometric transmission signal;
and wherein the ratio is the ratio of the derived transmission signal and the derived reflection signal, thereby avoiding a division by small signals.

Consequently, in this embodiment, the output signal includes a ratio of a signal derived from the transmission signal and a signal derived from the reflection signal. It has been realised by the inventors that such a ratio also improves the signal-to-noise ratio by reducing the noise caused by variations in the light intensity of the reflected laser beam. Furthermore, by adding an offset to the denominator of the ratio, instabilities of the resulting signal due to a division by a small signal are avoided. Furthermore, if the offsets are selected to be small compared to the average of the transmission and the reflection signals, their precise values do not influence the output signal during most of the measurements. Only when the input intensity is reduced, e.g. within an area of decreased reflectance of the object under examination, a non-optimal choice of the offsets results in increased noise. In some embodiments, each of the offsets is selected to be smaller than the average of the interferometric transmission and reflection signals at the working point of the interferometer, preferably smaller than 50% of said average, more preferably smaller than 20% of the average, most preferably smaller than 10% of the average, e.g. 5% of the average. Nevertheless, the optimal choice of the values of the offset parameters may depend on factors such as the properties of the surface to be inspected, the laser intensity, the signal amplification, etc.

In one embodiment, at least one of the transmission and reflection signal is further scaled by a corresponding scale factor, thereby allowing a suitable scaling of the resulting output signal. For example, the subsequent signal processing circuits may require a certain minimum signal strength in order to provide a god signal-to-noise ratio. Nevertheless, in some embodiments the scaling factors may be predetermined by the amplification of the system, e.g. the divider circuit.

In one embodiment, the first and second offsets are selected such that the ratio signal is substantially constant in the working point of the interferometer. In one embodiment, the first and second offsets are selected to have a ratio corresponding to the ratio of the reflection signal and the transmission signal in the working point. If the transmission and/or reflection signals are scaled, the ratio of the offsets is selected to correspond to the ratio of the scaled signals.

In another embodiment, the ratio is determined prior to any high and/or low pass filtering of the transmission signal and the reflection signal, thereby ensuring that the signals are in phase with each other prior to the determination of the ratio.

In another embodiment, the output signal is used to adjust the resonance frequency of the optical interferometer as described below.

The property to be detected may be ultrasound waves or transients causing a surface motion of the object in the form of elastic vibrations. The vibrations are detectable as a modulation of the scattered/reflected beam due to a Doppler shift. Hence, the generated output signal corresponds to/is indicative of the surface emotions, e.g. vibrations, of the object, thereby allowing detection and classification of defects in an object on the basis of the detected ultrasound waves, e.g. from the number and times of arrival of the ultrasound waves. It is understood, however, that the method may also be applied to the detection of other properties that are detectable by ultrasonic detection and inspection.

Further preferred embodiments are disclosed in the dependent claims.

According to a second aspect of the invention the above and other problems are solved by providing an improved stabilisation of the resonance frequency of the interferometer based on a derived ratio signal.

Accordingly, the invention further relates to a method of controlling the resonance frequency of an optical interferometer, the method comprising
receiving a laser beam with said optical interferometer to produce at least one of an interferometric transmission signal and an interferometric reflection signal; and
adjusting the resonance frequency of the optical interferometer in response to a control signal generated from a ratio of a first and a second signal, each being substantially proportional to the intensity of the received laser beam in a working point of the interferometer;
wherein the method comprises generating the control signal by
generating a first derived signal by adding a first constant offset to the first signal;
generating a second derived signal by adding a second constant offset to the second signal;
generating the control signal as a ratio of the first and second derived signals.

As described herein, the above combination of derived signals is substantially insensitive to variations in the intensity of the reflected laser light. Consequently, a feedback based on this combination of signals allows maintaining of the optimal distance between the reflectors of the interferometer even when the intensity of the reflected laser beam changes or even substantially vanishes temporarily, e.g. due to a scanning over the surface of an object. Hence, periods of missed signals are avoided, as it takes time and may even require readjustments to re-capture the signal once the detector system has become unstable due to a vanishing input signal.

It is an advantage of the invention that it provides an improved stability of the Fabry-Perot interferometer even when the light intensity of the laser beam received by the interferometer varies. Consequently, embodiments of the present invention have been found particularly advantageous for the inspection of moving objects, such as metal objects, i.e. when the detection laser beam is directed to a position on the surface of the object where the position is moved relative to the surface, even when the scanning occurs at a high speed.

In one embodiment, the resonance frequency of the optical interferometer is adjusted in response to a control signal generated from a combination of the interferometric transmission signal and the interferometric reflection signal. Accordingly in this embodiment the first derived signal is a derived reflection signal, derived from the interferometric reflection signal by adding a first offset to the interferometric reflection signal and the second derived signal is a derived transmission signal, derived from the interferometric transmission signal by adding a second offset to the interferometric transmission signal. It has tuned out that this combination of transmission and reflection signals provides a particular stable control signal that is insensitive to noise due to variations of the surface to be inspected.

In one embodiment, the optical interferometer comprises a cavity defined by two reflectors, the cavity having a predetermined length, and the resonance frequency is adjusted by adjusting the length of the cavity. A feedback control based on a combination of the interferometric transmission signal and the interferometric reflection signal significantly improves the stability of an optical interferometer and, in particular, a Fabry-Perot interferometer. In one embodiment, the derived signals are generated by scaling the respective signals and adding respective offsets as described above and in the following.

It is a further advantage of the invention that it provides an improved stability without the need of a large number of additional optical components.

In one embodiment, at least one of the transmission and reflection signal is further scaled by a corresponding scale factor, thereby allowing a suitable scaling of the resulting output signal.

In one embodiment, the first and second offsets are selected such that the ratio signal is substantially constant in the working point of the interferometer. In one embodiment, the first and second offsets are selected to have a ratio corresponding to the ratio of the reflection signal and the transmission signal in the working point. If the transmission and/or reflection signals are scaled, the ratio of the offsets is selected to correspond to the ratio of the scaled signals. Hence, for a suitable choice of the offsets and, optionally, the scale factors, the scaled ratio signal provides a constant working point even when the incoming light intensity vanishes or at least becomes very small.

In another embodiment, the ratio is determined prior to any high and/or low pass filtering of the transmission signal and the reflection signal, thereby ensuring that the signals are in phase with each other prior to the determination of the ratio.

In some embodiments, the ratio signal is also used as an output signal of the interferometer as described above and in the following. In other embodiments, the output signal is provided as the transmission signal, the reflection signal or by a combination of the transmission- and reflection signals.

In one embodiment, the output signal is generated by
scaling at least one of the interferometric reflection signal and the interferometric transmission signal relative to the corresponding other signal by a predetermined relative scale factor; and
combining the scaled interferometric reflection and transmission signals with one another to obtain the output signal.

In particular, the signal-to-noise ratio of the detection signal may be improved in the presence of variations in the received light intensity when the interferometric reflection signal and the interferometric transmission signal are scaled relatively to each other by a predetermined relative scale factor before they are combined with one another to form a weighted conjugate signal.

The noise in the transmission and the reflection signals have different magnitude, partly due to different DC background levels in the transmission and reflection signals and partly due to different sensitivities of the respective detectors. Consequently, an improved cancellation of the noise in a conjugate signal is achieved by providing a relative scaling of the signals and by combining the scaled interferometric reflection signal with the interferometric transmission signal to obtain the output signal.

When combining the scaled interferometric reflection and transmission signals with one another comprises subtracting the scaled interferometric reflection and transmission signals from another, the noise reduction is further improved, because the noise in the reflection signal is in phase with the noise of the transmission signal and proportional to the intensity, at least as long as the variations are not too fast compared to the bandwidth of the interferometer.

In one embodiment the scale factor is a predetermined constant scale factor, thereby providing a particularly simple implementation, e.g. by means of a predetermined amplification/attenuation of one or both signals.

It is understood that the relative scaling may be provided by scaling the transmission signal or the reflection signal, or by scaling both signals by different scale factors.

In another preferred embodiment, the method further comprises
detecting a noise level of the output signal; and
adaptively controlling the scale factor to reduce the detected noise level.

Consequently, by adaptively controlling the scale factor in response to the measured noise level, an automatic optimisation of the scale factor and, thus, of the signal-to-noise ratio is provided.

Further preferred embodiments are disclosed in the dependant claims.

The above method of adjusting the resonance frequency of an optical interferometer may advantageously be used for adjusting the resonance frequency of the optical interferometer in the above-described methods for detecting a property of an object. Hence, each of the weighted conjugate signal and the ratio signals described herein may be used as output of the interferometer and/or as a control signal for adjusting the resonance frequency of the interferometer.

The present invention can be implemented in different ways including the methods described above and in the following and corresponding devices, each yielding one or more of the benefits and advantages described in connection with the above-mentioned methods, and each having one or more preferred embodiments corresponding to the preferred embodiments described in connection with the above-mentioned methods or disclosed in the dependant claims.

In particular, according to the first aspect, the invention further relates to a detection device for detecting a property of an object, the device comprising
a detection laser arrangement adapted to direct a detection laser beam to the object to produce a scattered laser beam modulated corresponding to a motion of said object;
an optical interferometer adapted to receive the scattered laser beam and to produce an interferometric transmission signal and an interferometric reflection signal corresponding to the motion of the object;
signal processing means adapted to generate an output signal from the interferometric transmission signal and the interferometric reflection signal, the output signal being indicative of the property to be detected;
wherein the signal processing means is adapted to generate the output signal a ratio of a signal derived from the interferometric transmission signal and a signal derived from the interferometric reflection signal.

In one embodiment, the optical interferometer has a resonance frequency, and the detection device further comprises control means for adjusting the resonance frequency of the optical interferometer in response to a control signal generated from a combination of the interferometric transmission signal and the interferometric reflection signal.

According to the second aspect, the invention further relates an optical interferometer adapted to receive a laser beam and to produce at least one of an interferometric transmission signal and an interferometric reflection signal; wherein the optical interferometer comprises control means adapted to adjust the resonance frequency of the optical interferometer in response to a control signal;
wherein the optical interferometer further comprises signal processing means adapted to generate the control signal from a ratio of a first and a second signal, each being substantially proportional to the intensity of the received laser beam in a working point of the interferometer, by
generating a first derived signal by adding a first offset to the first signal;
generating a second derived signal by adding a second offset to the second signal; and
generating the control signal as a ratio of the first derived signal and the second derived signal.

In some embodiments, the laser is a CW laser, and the system is a single-cavity interferometer system, thereby providing a compact, inexpensive solution.

The above and other aspects of the invention will be apparent and elucidated from the embodiments described in the following with reference to the drawing in which:

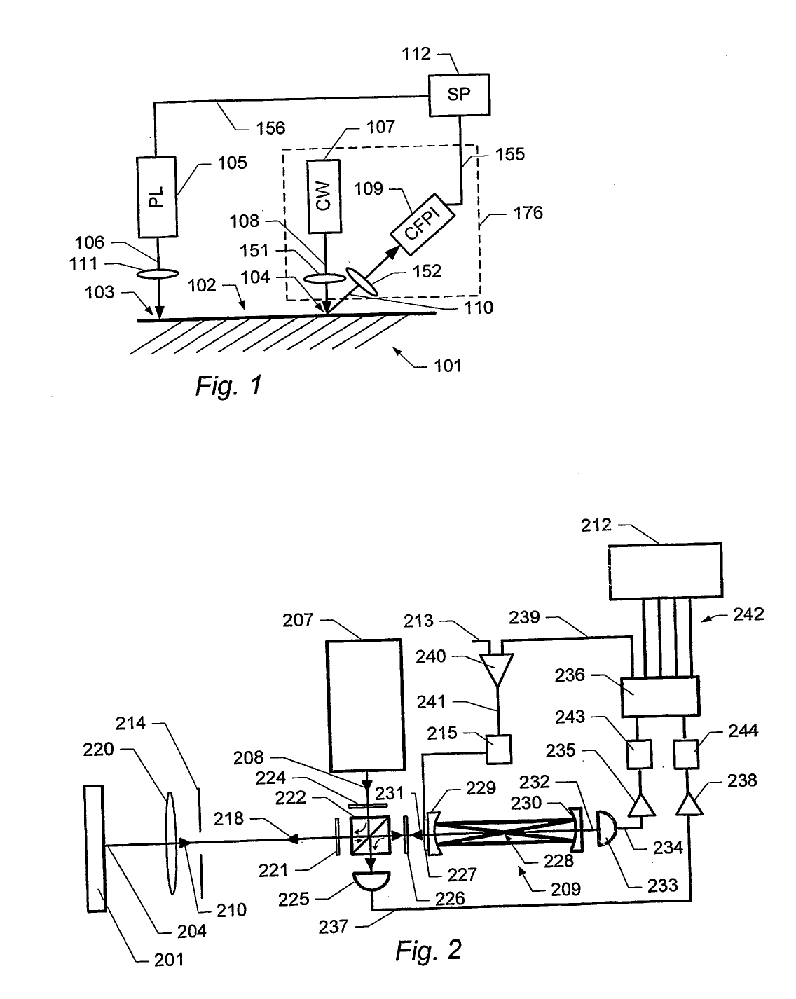

FIG. 1 shows a schematic block diagram of a laser-ultrasound inspection device for inspecting a metallic object for defects;

FIG. 2 shows a schematic block diagram of a device for detecting ultrasound pulses travelling in an object;

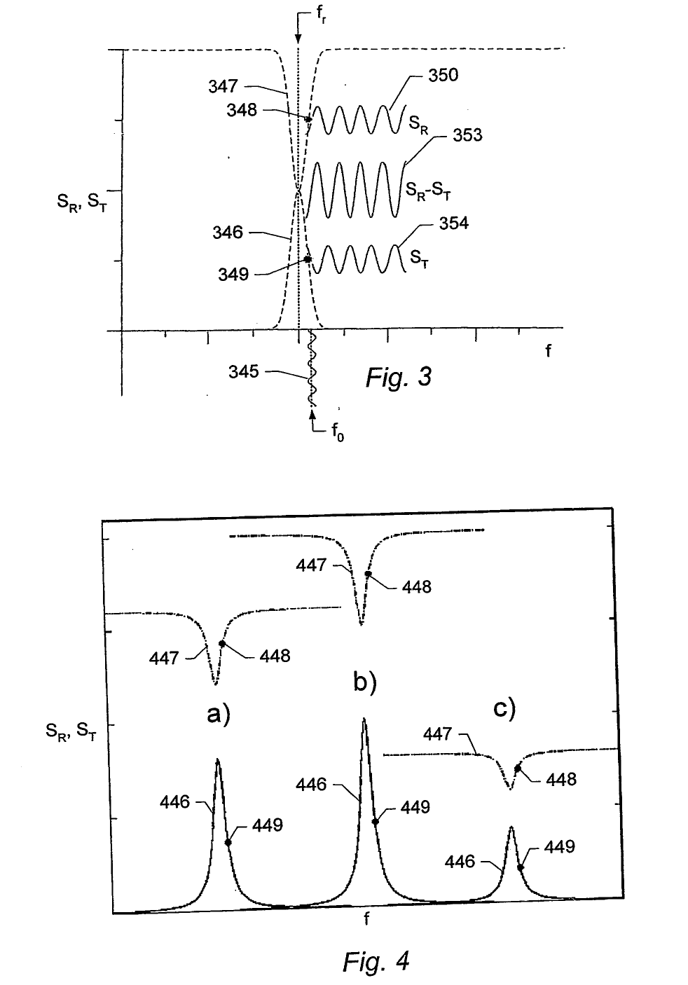

FIG. 3 illustrates the generation of output signals from an optical interferometer;

FIG. 4 illustrates the dependency of the working point of the interferometer on variations of the intensity of the received laser beam;

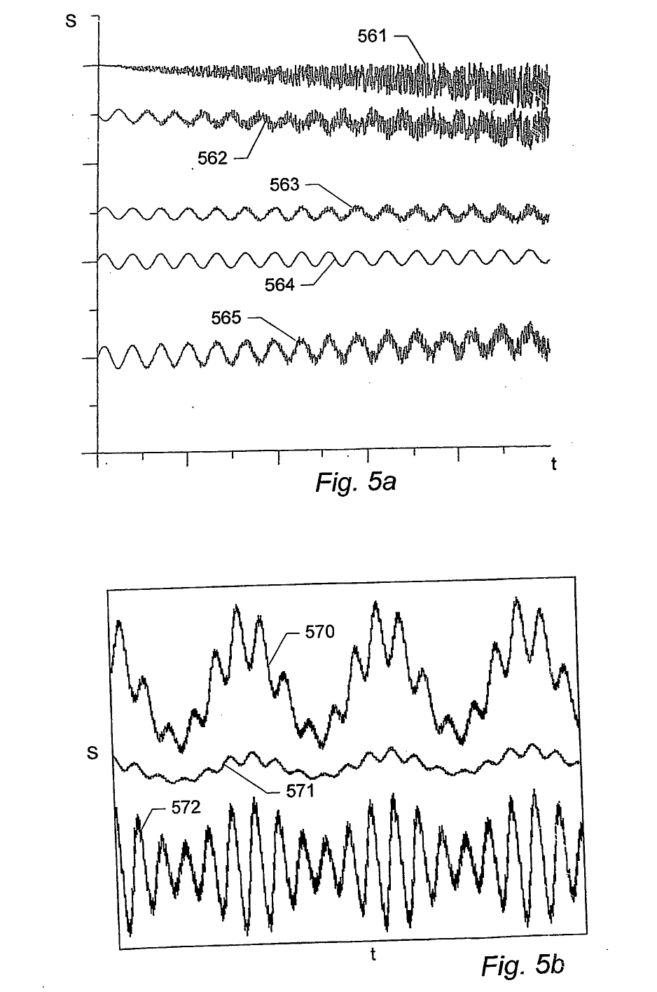

FIGS. 5a-b illustrate the noise reduction achieved by a weighted conjugate signal;

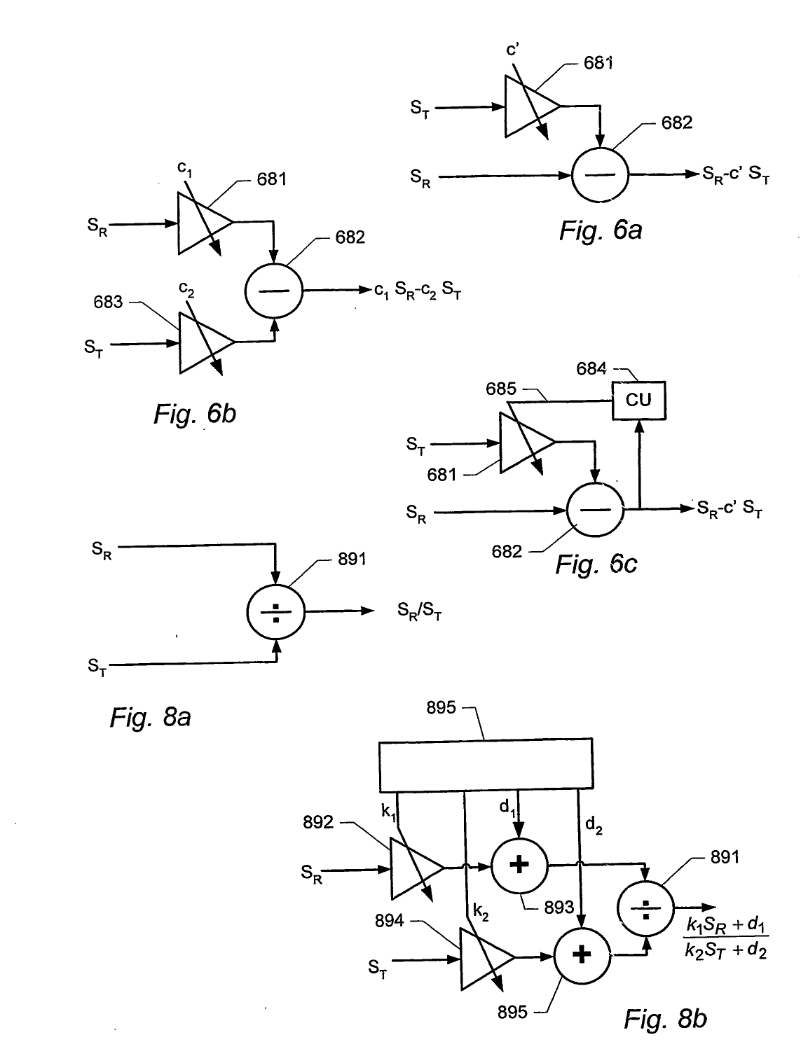

FIGS. 6a-c illustrate block diagrams of different examples of arrangements for generating the weighted conjugate signal;

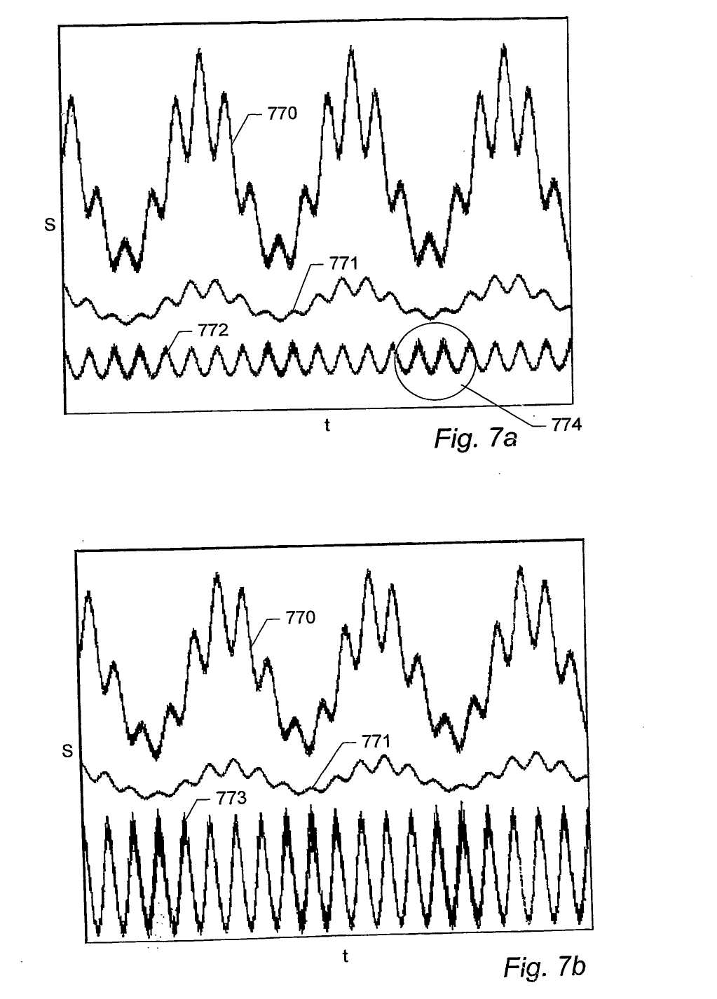

FIGS. 7a-b illustrate the effect of intensity variations on the ratio of the transmission and the reflection signal and on the ratio of the signals derived from the transmission and the reflection signal by respective scaling and offsets, respectively;

FIGS. 8a-b illustrate block diagrams of different examples of arrangements for generating a ratio signal, e.g. as an output signal or as a feedback signal for controlling the CFPI cavity;

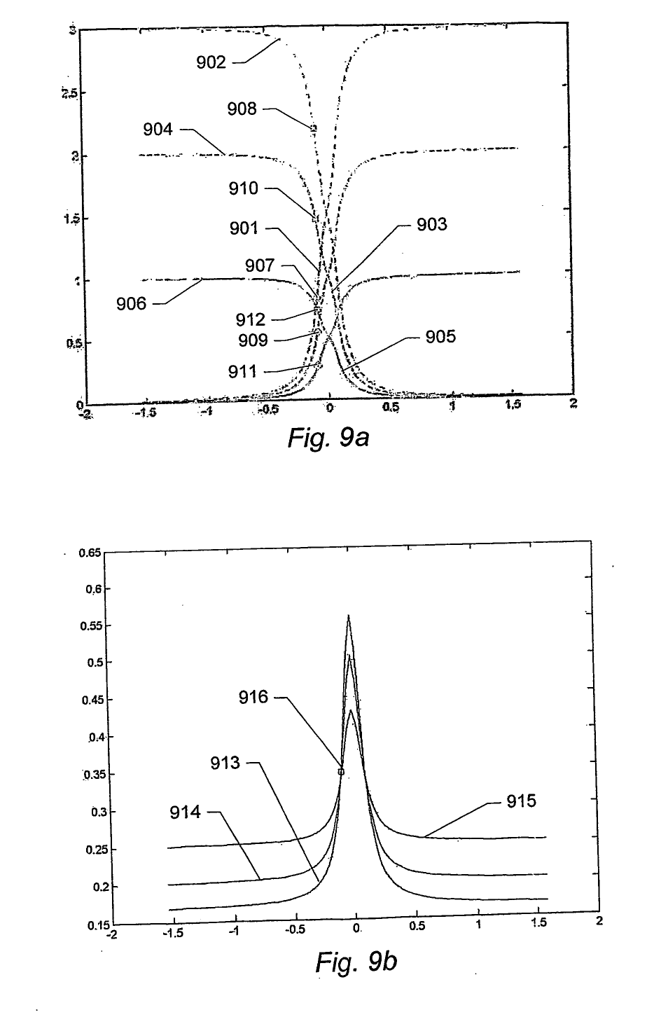

FIGS. 9a-b illustrate the selection of offsets and scaling factors for the ratio signal described herein.

FIG. 1 shows a schematic block diagram of a laser-ultrasound inspection device for inspecting a metallic object for defects. The device comprises a laser beam source 105 which directs an excitation laser beam 106 to an excitation position 103 on a surface 102 of a an object 101, e.g. the running surface of a rail. The laser beam source includes a pulsed, high repetition frequency laser, e.g. a pulsed Nd:YAG laser with a repetition frequency of 500 Hz or more. In one embodiment a pulse duration of 10 ns (FWHM) was used with a peak power of the laser of 2-3MW. The laser beam 106 is focused by a lens 111 or other suitable optical arrangement on the surface 102, e.g as an elongated focal spot or a point-like/circular spot. In embodiments where the laser-ultrasonic generation is operated in the ablation or plasma regime, the power density of the laser is selected sufficiently high to ablate the surface. The pulsed laser beam 106 generates ultrasound pulses in the object originating from the excitation position 103, i.e. the excitation position 103 may be regarded as an ultrasonic source. Hence, in the above, an example of an ultrasound source using laser-induced generation of ultrasound waves is disclosed. It is understood, however, that other means of generating ultrasound waves in the material may be used, including other embodiments of laser-based arrangements, another example of which is disclosed in U.S. Pat. No. 5,080,491.

The laser-ultrasound inspection device further comprises a detection device 176 comprising a continuous wave (CW) detection laser source 107 that directs a detection laser beam 108 to a detection position 104 on the running surface 102 of the object 101. In one embodiment, the laser operates in the visible or near-infrared range. A CW detection laser provides a high data acquisition rate, thereby allowing an inspection of objects even at high scanning speeds. In one embodiment, a CW diode-pumped Nd:YAG laser with a wavelength of 532 nm and an intensity of 200 mW was used. The detection laser beam 108 is focused by a lens 151 or another suitable optical arrangement into a point-like focal spot 104 displaced at a certain distance from the excitation spot 103.

The detection laser beam 108 is scattered/reflected on the surface 102 resulting in a scattered/reflected detection laser beam 110. The scattered/reflected detection laser beam is modulated by the motion of the reflecting surface via a Doppler shift of the frequency of the scattered/reflected detection laser beam.

The frequency shift of the scattered/reflected detection laser beam 110 is detected by a confocal Fabry-Perot interferometer (CFPI) 109. To this end, the scattered/reflected detection laser beam 110 is collected by lens 152 or by another suitable optical arrangement and directed into the CFPI 109. The CFPI is arranged to have a resonance frequency corresponding to the frequency fₒ of the detection laser as described in greater detail below. The CFPI detects the frequency shift of the scattered/reflected detection laser beam 110 with respect to the resonance frequency of CFPI cavity. The CFPI generates a detection signal 155 representing measured light intensity as a function of time. The detection signal is indicative of the modulation of the scattered/reflected detection laser beam 110 caused by the motion of the surface 102 which, in turn, is caused by the ultrasonic wave induced by the excitation laser beam 106 and propagated through or along the surface of the object 101. Since the ultrasonic wave interacts with defects in the object, the detection signal carries information about such defects.

An embodiment of the detection device 176 will be described in connection with FIG. 2 below.

The detection signal 155 is fed into a signal processing unit 112, e.g. a computer or microprocessor comprising a data acquisition circuit with a sampling rate sufficiently high to resolve the signal and to keep pace with the repetition rate of the generating pulsed laser. The signal processing unit 112 further receives a trigger signal 156 from the excitation laser source 105 indicative of the times at which the excitation laser source 105 fires a laser pulse to the surface 102.

In some embodiments, the signal processing unit 112 processes the received detection signal and provides estimates of the type and location of any detected defects in the object, e.g. as described in “A conjugate optical confocal Fabry-Perot interferometer for enhanced ultrasound detection”, by Q Shan et al. (ibid.).

Hence, in the above, a device for non-contact laser-ultrasound detection is disclosed. It is an advantage of laser-ultrasound detection that it provides a high spatial resolution of the detection, due to the high bandwidth of the laser-generated pulses. Consequently, highly reliable defect detection is provided. It is a further advantage, that no physical contact of the detector with the object is required.

FIG. 2 shows a schematic block diagram of a device for detecting ultrasound pulses travelling in an object.

The detection device comprises a detection laser 207, preferably a continuous wave or a long-pulse laser. In one embodiment, a CW diode-pumped Nd:YAG laser with a wavelength of 532 nm and an intensity of 200 mW was used. The detection laser beam from the detection laser 207 is directed via an optical arrangement to a detection spot 204 on the surface of the object 201. In this embodiment, the optical arrangement comprises a polarisation beam splitter 222 and a lens 220. Depending on the polarisation of the incident light with respect to the plane of incidence, the polarisation beam splitter transmits nearly all the incident light or reflects nearly all the incident light. Therefore, a half-wave plate 224 is provided in the beam path of the laser beam 208 in front of the polarisation beam splitter 222, causing the beam to be linearly polarised in the plane across the direction of incidence and, thus, reflected towards the object 201, as indicated by arrow 218. Furthermore, the arrangement comprises a quarter-wave plate 221 in the beam path between the polarisation beam splitter and the object 201, which transforms the incident beam 218 in a circularly polarised beam. On return from the surface of the object 201, the reflected beam again passes through the quarter-wave plate 221 causing the beam to be linearly polarised in the direction of the incident plane. Consequently, the reflected beam is transmitted by the polarisation beam splitter 222 towards a confocal Fabry-Perot interferometer 209.

Hence, in this embodiment the beam paths of the detection beam 218 and the reflected beam 210 are combined. It is understood that, alternatively, the beam paths of the detection beam and the reflected beam may be made separate as was illustrated in the example of FIG. 1. It is an advantage of a combined beam path that it is easier to adjust and less sensitive to variations in the distance between the object and the device.

The Fabry-Perot interferometer 209 comprises a concave front mirror 229 and a concave rear mirror 230 defining a cavity 228. The reflected beam enters trough the front mirror. Generally, a Fabry-Perof interferometer may be operated in transmission mode and/or reflection mode. In transmission mode an output beam is coupled out at the rear mirror and in reflection mode an output beam is coupled out at the front mirror.

The intensity of the transmission and reflection beams depend on the frequency of the incoming beam 210 relative to the resonance frequency of the CFPI, as will be described in more detail below. The resonance frequency of the CFPI is tuned by adjusting the length of the cavity 228, i.e. the distance between the mirrors 229 and 230. To this end, the front mirror 229 is mounted on a piezo ring or piezo pusher 227 so that the spacing between the mirrors may be adjusted and the resonance frequency is fine-tuned to the frequency of the detection laser 207. It is understood that, alternatively, the rear mirror may be adjusted.

In the present embodiment of the invention, a reflection output beam 231 is coupled out at the front mirror 229 and a transmission beam 232 is coupled out at the rear mirror 230. The transmission beam is detected by a photo-detector 233 producing a transmission signal S_{T} indicative of the intensity of the transmission beam. Similarly, the reflection beam is detected by a photo-detector 225 resulting in a reflection signal S_{R}. To this end, a quarter-wave plate 226 is positioned between the polarisation beam splitter 222 and the front mirror 229 of the CFPI. Hence, the reflected beam 210 transmitted by the polarisation beam splitter is circularly polarised by the quarter-wave plate 226 prior to entering the CFPI and, consequently, the returning reflection beam 231 is linearly polarised by the quarter-wave plate, causing the reflection beam 231 to be reflected by the polarisation beam splitter towards the detector 225.

The transmission signal S_{T} and the reflection signal S_{R} are amplified by pre-amplifiers 235 and 238, digitised by respective A/D converters 243 and 244 and fed into a digital signal processor 236, e.g. a Field Programmable Gate Array (FPGA), a suitably programmed computer including a data acquisition board, or other suitable processing means. The digital signal processor outputs one or more digital signals 242 that are fed into a processing circuit, e.g. a personal computer, for subsequent data analysis, such as the detection and classification of ultrasound transients. Alternatively, the signal/data processing units 236 and 212 may be combined in a single processing unit.

It is further understood that, in some embodiments, the combination of the transmission and reflection signals, is implemented by analogue signal processing circuitry.

In one embodiment, one of the digital signals 242 represents a ratio of the transmission and reflection signals, e.g. S_{T}/S_{R}, or a scaled ratio of the transmission and reflection signals, e.g. according to (k₁·S_{T}+d₁)/(k₂·S_{R}+d₂) with suitable scale factors k₁, k₂, and suitable offsets d₁, d₂, as will be described below. Alternatively or additionally, one of the digital signals 242 represents a weighted conjugate signal such as c₁·S_{R}−c₂·S_{T} as will be described below. Both the weighted conjugate signal and the scaled ratio signal have the advantage that they reduce the noise in the output signal caused by the scanning over a surface or by instabilities of the detection laser. The ratio signal has the further advantage that it provides a low-noise output signal that is insensitive to tuneable parameters. The scaled ratio signal has the further advantage that it provides an output signal with substantially constant amplitude irrespective of the intensity of the incoming light. Furthermore, the scaled ratio signal has the advantage that it is stable and has a low noise even when the incoming light intensity varies strongly.

Optionally, the signal processor 236 outputs one or more further signals 242, e.g. the transmission signal S_{T} and/or the reflection signal S_{R},

The digital signal processor 236 further outputs an analogue feedback signal 239 for controlling the CFPI. As will be described in greater detail below, in one embodiment the analogue feedback signal represents a ratio of the scaled and offset signals according to (k₁·S_{T}+d₁)/(k₂·S_{R}+d₂). Alternatively, the feedback signal represents the weighted conjugate signal described above and in the following. The feedback signal 239, optionally after a low-pass filtering, is compared to a constant reference signal 213 by a differential amplifier 240, and the resulting error signal 241 is fed to a control circuit 215 controlling the piezo pusher 227. Hence, if the distance between the mirrors is two short or too long, the DC level of the feedback signal 239 increases or decreases resulting in a corresponding error signal 241.

In some embodiments, the detection device further comprises a spatial filter 214, e.g. an aperture, limiting the reflected beam. The aperture 214 ensures that the same part of the spatially distributed laser beam, i.e. the same part of the speckle pattern generated from the reflection on the surface is incident on both detectors 225 and 233, thereby further improving the cancellation of the noise in the weighted conjugate signal.

Experiments and calculations have shown that the reflectivity of the mirrors of the CFPI is preferably selected between 92% and 98%, most preferably between 94% and 96%. In an application of the present method for the detection of defects in rails, the best results have been obtained with a reflectivity of 95%. It is understood, however, that the optimal choice of the reflectivity may depend on the specific application.

It is understood that, alternatively or additionally, the signal processor 236 may at least partly be implemented by analogue signal processing circuitry.

FIG. 3 illustrates the generation of output signals from an optical interferometer.

In particular, FIG. 3 schematically shows the resonance curve 346 of the CFPI in transmission mode and the corresponding resonance curve 347 in reflection mode as functions of the frequency f of the incoming laser beam 210. The intensities have peaks at the resonance frequency fᵣ of the CFPI. The exact form of the curves depends on the properties of the CFPI, such as the reflectivities of the mirrors and the length of the cavity, and on the wavelength of the light. Preferably, the resonance frequency of the CFPI is controlled to be slightly displaced with respect to the frequency fₒ of the detection laser beam, such that the laser frequency fₒ is located on the slope (generally at half maximum height) of the resonance peak of the Fabry-Perot cavity, defining the working points 348 and 349 for the reflection and transmission mode, respectively. Consequently, frequency modulations of the incident beam 345 result in corresponding variations of the intensities 350 and 354 of the reflection signal and the transmission signal, respectively.

More specifically, the reflection signal S_{R} and the transmission signal S_{T} may be expressed as

$${S}_{T} ∝ {l}_{0} \frac{{( 1 - R )}^{2}}{1 + {R}^{2} - 2 R cos δ} , {S}_{R} ∝ {l}_{0} ( \frac{2 R ( 1 - cos δ )}{1 + {R}^{2} - 2 R cos δ} + const ) ,$$

where I₀ denotes the input intensity, R denotes the reflectivity of the mirrors, and δ=8πd I λ is the detuning of the CFPI which is determined by the ratio of the distance d between the mirrors and the wavelength λ of the incident light.

Hence, both S_{T} and S_{R} are proportional to the intensity I₀ of the incoming light. Furthermore, as illustrated by FIG. 3, the variations of S_{R} and S_{T} are in opposition to each other.

The modulation of the intensity of the reflection and transmission signals for a given variation of I₀ is largest where the gradient of the resonance curves 346 and 347 is largest. This position is referred to as the working point δ_{wp} and is illustrated by the dots 348 and 349 in FIG. 3. However, when the signal intensity varies, the signal level at the working point also changes, thereby changing the DC background level. Consequently, variations of the intensity of the incoming light induce noise in the transmission and reflection signals.

FIG. 4 illustrates the dependency of the working point of the interferometer on variations of the intensity of the received laser beam. FIGS. 4a-c show transmission and reflection resonance curves 446 and 447, respectively and the corresponding working points 448 and 449 for three different signal intensities. When the intensity of the input beam varies, e.g. due to a scanning over the surface of an object, the transmission and reflection signal will be noisy. Since the noise depends on the intensity variation, the noise in the transmission and reflection signals is in phase with respect to each other, at least as long as the intensity variations are not too fast compared to the bandwidth of the CFPI. Furthermore, the noise level due to intensity variations is proportional to the intensity of the respective signal. The noise due to intensity variations is an important limiting factor when applying ultrasound laser detection for scanning at high speeds. In particular, when inspecting objects having a rough surface, the reflected laser beam generates a speckle pattern. This speckle pattern changes when scanning over the surface resulting in noise corresponding to rapid intensity variations of the reflected light. The frequency of these variations increases with increasing scanning speed.

Again referring to FIG. 3, since the noise in the transmission and reflection signals are in phase with respect to each other while the respective signal variations due to the frequency modulation are in opposition to each other, an improved signal-to-noise ratio may be obtained by generating a conjugate signal S_{T}−S_{R}, as illustrated by signal 353.

The signal to noise ratio may be further improved by generating a weighted conjugate signal wherein at least one of the transmission and reflection signals is scaled relative to the corresponding other signal before subtraction, e.g. according S_{T}−c·S_{R}, as will be illustrated with reference to FIG. 5, or by generating a ratio signal, e.g. S_{T}/S_{R} or a scaled ratio signal, e.g. according to (k₁S_{T}+d₁)/(k₂S_{R}+d₂ as will be illustrated with reference to FIG. 7.

FIGS. 5a-b illustrate the noise reduction by means of a weighted conjugate signal.

FIG. 5a illustrates a number of simulated signals as functions of time t. The top signal 561 illustrates the simulated intensity of the incoming light, i.e. the light reflected by the object, wherein the noise level is gradually increased.

Signals 562 and 563 illustrate the corresponding reflection signal S_{R} and transmission signal S_{T}, respectively, generated by the CFPI. The reflection signal 562 has a higher DC level than the transmission signal 563.

Consequently, the noise level in the reflection signal due to intensity variations is also larger, because the noise level is proportional to the signal intensity. A difference in noise level can also be caused by different sensitivities of the respective photo detectors.

The signal 565 corresponds to the conjugate signal S_{T}−S_{R}. Even though the noise level in the conjugate signal 565 is considerably reduced compared to the reflection signal 562, the conjugate signal still has a considerable noise level.

The cancellation of the noise is improved by generating a weighted conjugate signal. This is illustrated by signal 564 which corresponds to the signal S_{T}−c·S_{R} where, in this example c=1/3. The resulting weighted conjugate signal has a significantly improved signal-to-noise ratio, substantially independent of the intensity of the incoming light. In general, c is a predetermined constant which may be adjusted to minimise the noise of the weighted conjugate signal, e.g. by providing an adjustable amplifier or attenuator for one or both of the signals, as illustrated in FIGS. 6a-c. It is understood that, alternatively, the transmission signal may be scaled. Furthermore, additionally or alternatively, the overall sign of the weighted conjugate signal may be reversed.

In the example of FIG. 5a, the only noise contribution in signals 562 and 563 is the contribution proportional to the signal level. Furthermore, in the example of FIG. 5a, the noise contribution has a higher frequency than the Doppler signal. However, in most practical applications the intensity-dependant noise has a lower frequency than the Doppler signal and there will be additional uncorrelated noise, e.g. electronic noise, optical shot noise, etc. Such a situation is illustrated in FIG. 5b.

FIG. 5b shows a simulated reflection signal 570 and a simulated transmission signal 571. Each of the signals is generated as a superposition of a slowly varying noise contribution depending on the overall intensity level, a higher frequency contribution with an amplitude proportional to the light intensity, and a constant high-frequency noise contribution. The slowly varying contributions of signals 570 and 571 are in phase with each other simulating low frequency variations of the DC level, e.g. due to the scanning over the surface. The high frequency contributions of the respective signals are in opposition, thereby simulating the modulation induced by a Doppler shift of the reflected laser beam. The high frequency noise simulates uncorrelated noise such as thermal noise in the detectors, pre-amplifiers, etc. The third signal 572 corresponds to the weighted conjugate signal S_{T}−cS_{R}. In the weighted conjugate signal the low frequency noise is cancelled out, while the Doppler-induced signal is still present. The amplitude of the weighted conjugate signal 572 depends on the original light intensity, i.e. varies with the low-frequency intensity fluctuations. The noise level of the high-frequency uncorrelated noise in the weighted conjugate signal is constant.

It is understood that the preferred numeric value of the weight factor c, or the weight factors c₁ and c₂, depend on the parameters of the actual setup, e.g. the reflectivity of the mirrors of the CFPI, the adjustment of the quarter-wave plates, properties of any optical filters in the beam path, possible differences in the two photo-detectors which may vary due to the temperature etc. The scale factor may be determined based on the respective light intensity levels at the respective photodetectors for the interferometric transmission and reflection signals. Alternatively, the scale factor may be determined by monitoring the respective levels of noise, due to variations of intensity, of the interferometric transmission and reflection signals, while scanning over a surface. Preferably, for the purpose of determining the scale factor, the intensity levels are compensated for offsets caused by imperfect polarisation, by the photo detectors, etc. The value of c may then be adjusted as to optimize the signal-to-noise ratio.

FIGS. 6a-c illustrate block diagrams of different examples of arrangements for generating the weighted conjugate signal. In the embodiment of FIG. 2, the signal processing block 236 performs the calculation of the weighted conjugate signal and outputs the weighted conjugate signal as one of the signals 242.

In the example of FIG. 6a the transmission signal S_{T} is fed through an amplifier 681 with adjustable amplification. The amplified signal and the reflection signal S_{R} are fed into a subtraction circuit 682 generating the weighted conjugate signal. It is understood that, aternatively, the reflection signal may be attenuated.

In the example of FIG. 6b, both signals are amplified/attenuated by respective adjustable amplifiers/attenuators 681 and 683, and the amplified/attenuated signals are subsequently subtracted from another by subtraction circuit 682 resulting in the weighted conjugate signal c₁·S_{R}−c₂·S_{T}.

In the example of FIG. 6c, the arrangement of FIG. 6a is modified in that the adjustable amplifier is controlled by a feedback signal generated by a control circuit 684. The control circuit 684 receives the generated scaled signal, estimates the signal noise and/or compares the signal level with a reference level, and generates a corresponding control signal 685 to control the amplifier.

It is an advantage that the generation of the weighted conjugate signal may be implemented by standard electronic components or signal processing functions and, in particular, without constructional changes to the interferometer.

In the following, a preferred embodiment of the generation of the feedback signal for controlling the length of the CFPI cavity will be described. As illustrated in connection with FIG. 4 above, the DC level at the working point of the CFPI depends on the intensity I₀ of the incoming light. Consequently, variations of the light intensity also cause problems for the tuning of the CFPI cavity. Since the feedback loop is comparably slow, the stability of the CFPI is particularly reduced by low frequency variations of the input intensity.

The feedback system according to a preferred embodiment of the invention is based on the observation that a suitable combination of the transmission and reflection signals is insensitive to variations in the incoming laser intensity. Since the intensity variations of the reflected laser light cause variations in the transmission and reflection signal that are in phase with respect to each other, these variations can be cancelled out by a suitable relative scaling.

The feedback system may utilise the weighted conjugate signal described above. As discussed in connection with FIG. 5b, in the weighted conjugate signal the intensity variations caused by the scanning over a surface are cancelled out. In one embodiment the feedback system utilises a ratio of the transmission signal and the reflection signal, or of signals derived from the transmission and reflection signals. As will be illustrated below, such a ratio is also insensitive to variations in the incoming laser intensity. The scaled ratio signal provides a stable control signal even when the incoming light intensity varies substantially and may assume small signal values.

FIGS. 7a-b illustrate the effect of intensity variations on the ratio of the transmission and the reflection signal and on the ratio of the signals derived from the transmission and the reflection signal by respective scaling and offsets, respectively.

FIG. 7a shows a simulated reflection signal 770 and a simulated transmission signal 771. Each of the signals is generated as a superposition of a slowly varying sine wave, a higher frequency sine wave with an amplitude proportional to the slowly varying sine wave, and a high frequency noise contribution. The slowly varying sine contributions of signals 770 and 771 are in phase with each other simulating low frequency variations of the DC level. The high frequency sine contributions of the respective signals are in opposition, thereby simulating the modulation induced by a Doppler shift of the reflected laser beam. The high frequency noise simulates uncorrelated noise such as thermal noise in the detectors, pre-ampliflers, etc. Hence, the signals 770 and 771 correspond to the signals 570 and 571, respectively, of FIG. 5b. The third signal 772 corresponds to the ratio of signals 770 and 771. As can be seen, the low-frequency in-phase signal contribution is cancelled out in the relative signal 772, and the higher frequency signal has constant amplitude. Finally, the level of the high frequency noise is largest where the level of the low-frequency sine is lowest, e.g. as indicated by reference numeral 774.

FIG. 7b shows the same simulated reflection signal 770 and transmission signal 771 as in FIG. 7a. In this example, the transmission and reflection signal are scaled and offset prior to generating the relative signal 773 as a ratio of the scaled and offset signals. Hence, signal 773 corresponds to the signal (k₁·S_{T}+d₁)/(k₂·S_{R}+d₂). In the example of FIG. 7b, the slowly varying contribution of signal 771 is a factor 5 larger than in signal 772, and the constants are selected to be k₁=5, k₂1, d₁=d₂2.

A comparison of the ratio signals 772 and 773 with the weighted conjugate signal 572 of FIG. 5b shows that the amplitude of the ratio signals 772 and 773 is constant, i.e. does not depend on the light intensity. The uncorrelated noise, on the other hand, varies in the ratio signals 772 and 773 while it is constant in the weighted conjugate signal 572.

It is an advantage that the relative signal has an improved signal-to-noise ratio, since intensity variations in the transmission and reflection signals are cancelled out while the intensity modulation caused by the Doppler shift of the laser beam is maintained.

It is a further advantage that the DC level of the relative signal does not vary when the intensity of the reflected laser beam varies. Consequently, the relative signal is well-suited as a feedback signal allowing maintaining an optimised working point of the CFPI even when the intensity of the incoming laser beam varies, e.g. due to a scanning across a surface under inspection.

In the embodiment of FIG. 2 described above, the feedback signal is generated by processing block 236 as analogue signal 239.

FIGS. 8a-b illustrate block diagrams of different examples of arrangements for generating a ratio signal, e.g. as an output signal or as the feedback signal for controlling the CFPI cavity.

In the example of FIG. 8a the reflection signal S_{R} and the transmission signal S_{T} are fed in a division circuit 891 which generates the relative signal S_{T}/S_{R}.

Signal dividers typically become unstable when they divide by small signals. This problem is solved by adding suitable offsets to the incoming signals as will now be described with reference to FIG. 8b.

In the embodiment of FIG. 8b, the transmission signal S_{T} is initially fed through an amplifier 892 and an adder 893 to obtain the scaled and offset signal (k₁·S_{T}+d₁). Similarly, the transmission signal is scaled and offset by amplifier 894 and adder 895. The scaled and offset signals are then fed into the division circuit 891 resulting in the relative signal (k₁·S_{T}+d₁)/(k₂·S_{R}+d₂). It is an advantage of this embodiment that the inputs to the division circuit 891 are always offset from zero.

Preferably, the scaling constants k₁, k₂, and the offsets d₁, d₂ are selected such that (k₁·S_{T,WP}+d₁)/(k₂·S_{R,WP}+d₂) is constant, wherein S_{R,WP} and S_{T,WP} are the DC levels of the reflection and transmission signal, respectively, at the working point. It is understood that the optimal values of the scaling constants k₁, k₂, and the offsets d₁, d₂ are mutually dependant and depend on the relative magnitude of the signals. For example, three of the four parameters may be selected arbitrarily and the fourth parameter may subsequently be determined from the signal levels of the transmission and reflection signals or determined experimentally at the beginning of a measurement, e.g. by adjusting the fourth parameter while scanning over a surface until the working point remains constant.

The parameters may be set by considering the ratio (k₁·S_{T,WP}+d₁)/(k₂·S_{R,WP}+d₂) in the limiting cases of no incoming light intensity (S_{T,WP}=S_{R,WP}=O) resulting in the ratio to be equal to d₁/d₂ and very large incoming intensity, in which case the ratio approaches (k₁·S_{T,WP})/(k₂·S_{R,WP}). Hence the condition that the ratio should remain constant allows the determination of one of the four parameters, once the other three are selected, e.g. according to d₂=α·d₁·k₂/k₁, where α=S_{R,WP}/S_{T,WP} is the ratio of the signals at the working point.

Consequently, the arrangement comprises a control circuit 896 that determines the scaling constants k₁, k₂, and the offsets d₁, d₂ and controls the amplifiers 892 and 894 and the inputs to the adders 893 and 895.

FIGS. 9a-b illustrate the selection of offsets and scaling factors for the ratio signal described herein.

FIG. 9a shows the transmission and reflection signals for three different light intensities. Curves 901 and 902 are the resonance curves of the transmission signal S_{T} and the reflection signal S_{R}, respectively, at a high input intensity. Curves 903 and 904 are the resonance curves of the transmission signal S_{T} and the reflection signal S_{R}, respectively, at a medium input intensity. Curves 905 and 906 are the resonance curves of the transmission signal S_{T} and the reflection signal S_{R}, respectively, at a low input intensity. The working points 907, 908, 909, 910, 911, and 912 of the different signals are marked by respective symbols. In the example of FIG. 9a, the working points are selected to be such that the ratio of the transmission signal and the reflection signal is S_{T,WP}/S_{R,WP}=1/3. As can be seen from FIG. 9a, the working point varies as a function of the light intensity. The method described herein allows a stabilisation of the working point even in situations where the light intensity varies substantially, as it is the case when scanning with a laser ultrasound detector a surface with varying reflectivity.

FIG. 9b shows the resonance curves of the ratio signal (k₁·S_{T}+d₁)/(k₂·S_{R}+d₂) for the same light intensities as in FIG. 9a, i.e. curve 913 is the resonance curve of the ratio signal for the high light intensity, curve 914 is the resonance curve of the ratio signal for the medium light intensity, and curve 915 is the resonance curve of the ratio signal for the medium low intensity. In the example of FIG. 9b, the scaling constants are selected to be equal to 1, i.e. k₁=k₂=1, corresponding to no relative scaling. Furthermore, the offsets in the example of FIG. 9b are selected to be d₁=1 and d₂=(d₁·k₂·S_{R,WP})/(k₁·S_{T,WP})=3. It is noted that, if d₁ and d₂ are selected to be equal to zero, all three curves 913, 914, and 915 are equal. As can be seen from FIG. 9b, the curves intersect in the working point 916, i.e. the ratio signal is constant in the working point, even when the light intensity varies.

The parameters d₁, d₂ may be selected by the following procedure: First the ratio of the scaled signals k₁S_{T} and k₂S_{R} at the working point is determined. The actual ratio may differ slightly from the ratio set as the working point, e.g. due to optical losses in the system, different amplifications in the detector, etc. Hence, in a more accurate result may be achieved when the ratio of k₂S_{R} and k₁S_{T} is measured with the offsets d₁ and d₂ set to zero. Once the ratio of the scaled signals is determined, one of the offsets, e.g. d₁ is set to a selected value, e.g. a value that is small compared to both k₁S_{T} and k₂S_{R} at the working point. The input to the interferometer is then blocked, and the other offset, in this case d₂, is set such that the ratio of the offsets is equal to the ratio of k₂S_{R} and k₁S_{T}. It is also possible to set the offsets during operation, e.g. when scanning an object with a laser-ultrasound detector, by pre-setting three of the four parameters and adjusting the fourth parameter until the noise is minimised.

Although preferred embodiments of the present invention have been described and shown, the invention is not restricted to them, but may also be embodied in other ways within the scope of the subject matter defined in the following claims.

The present invention may advantageously be applied in the inspection of objects e.g. for defects, in particular in metal objects. The feedback control of the CFPI interferometer based on a scaled ratio of the signals has successfully been applied to the detection of defects in railway rails where an ultrasound inspection device was mounted on a railway vehicle and moved along the rail at speeds of 40-50 km/h. The weighted conjugate signal has successfully been applied to measurements on a rotating disk at speeds of more than 100 km/h.

The invention can be implemented by means of hardware comprising several distinct elements, by means of a suitably programmed microprocessor, and/or by a combination thereof.

It is noted that some of the features of the methods described herein may be implemented in software and carried out on a data processing system or other processing means caused by the execution of program code means such as computer-executable instructions. The term processing means comprises any circuit and/or device suitably adapted to perform the above functions. In particular, the above term comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

For example, the program code means may be loaded in a memory, such as a RAM, from a storage medium or from another computer via a computer network. Alternatively, the described features may be implemented by hardwired circuitry instead of software or in combination with software.

In the device claims enumerating several means, several of these means can be embodied by one and the same item of hardware, e.g. a suitably programmed microprocessor, one or more digital signal processor, one or more ASIC circuit, or a combination of the above. The mere fact that certain measures are recited in mutually different dependent claims or described in different embodiments does not indicate that a combination of these measures cannot be used to advantage.

It should be emphasized that the term “comprises/compdsing” when used in this specification is taken to specify the presence of stated features, integers, steps or components but does not preclude the presence or addition of one or more other features, integers, steps, components or groups thereof.

1. A method of detecting a property of an object, the method comprising
directing a detection laser beam to the object to produce a scattered laser beam modulated corresponding to a surface motion of said object;
receiving the scattered laser beam with an optical interferometer to produce an interferometric transmission signal and an interferometric reflection signal corresponding to the surface motion of the object;
generating an output signal from the interferometric transmission signal and the interferometric reflection signal, the output signal being indicative of the surface motion;
characterised in that the output signal is generated as a ratio of a signal derived from the interferometric transmission signal and a signal derived from the interferometric reflection signal.

2. A method according to claim 1, wherein the ratio of a signal derived from the interferometric transmission signal and a signal derived from the interferometric reflection signal is the ratio of the interferometric transmission signal and the interferometric reflection signal.

3. A method according to claim 1, further comprising
generating a derived reflection signal from the interferometric reflection signal by adding a first offset to the interferometric reflection signal; and
generating a derived transmission signal from the interferometric transmission signal by adding a second offset to the interferometric transmission signal;
and wherein the ratio is the ratio of the derived transmission signal and the derived reflection signal.

4. A method according to claim 3, wherein generating at feast one of the derived transmission signal and the derived reflection signal comprises scaling the corresponding one of the interferometric reflection signal and the interferometric transmission signal by a respective scale factor.

5. A method according to claim 3, wherein the first and second offsets are determined such that the ratio of the derived transmission signal and the derived reflection signal at the working point of the optical interferometer is substantially constant.

6. A method according to claim 1, further comprising directing the detection laser beam to a position on the surface of the object; and moving said position relative to the surface.

7. A method according to claim 1, wherein the object is a railway track rail.

8. A method according to claim 1, further comprising inducing said motion of the object by inducing an ultrasound wave traveling in the object.

9. A method according to claim 8, comprising directing a pulsed excitation laser beam to an excitation position on the surface of the object to induce the ultrasonic wave.

10. A method according to claim 1, wherein combining the interferometric transmission signal and the interferometric reflection signal is performed prior to any high and/or low pass filtering of the transmission signal and the reflection signal.

11. (canceled)

12. A method of controlling the resonance frequency of an optical interferometer, the method comprising
receiving a laser beam with said optical interferometer to produce at least one of an interferometric transmission signal and an interferometric reflection signal; and
adjusting the resonance frequency of the optical interferometer in response to a control signal generated from a ratio of a first and a second signal, each being substantially proportional to the intensity of the received laser beam in a working point of the interferometer;
characterised in that the method comprises generating the control signal by
generating a first derived signal by adding a first constant offset to the first signal;
generating a second derived signal by adding a second constant offset to the second signal;
generating the control signal as a ratio of the first and second derived signals.

13. A method according to claim 12, wherein generating at least one of the first derived signal and the second derived signal comprises scaling the corresponding first or second signal by a respective scale factor.

14. A method according to claim 12, wherein the first and second offsets are determined such that the ratio of the first derived signal and the second derived signal at the working point of the optical interferometer is substantially constant.

15. A method according to claim 12, wherein the resonance frequency of the optical interferometer is adjusted in response to a control signal generated from a combination of the interferometric transmission signal and the interferometric reflection signal; wherein the first derived signal is a derived reflection signal, derived from the interferometric reflection signal by adding a first offset to the interferometric reflection signal; and wherein the second derived signal is a derived transmission signal, derived from the interferometric transmission signal by adding a second offset to the interferometric transmission signal.

16. A method according to claim 15, wherein the ratio is determined prior to any high and/or low pass filtering of the transmission signal and the reflection signal.

17. A method according to claim 12, further comprising directing a detection laser beam to an object to produce a scattered laser beam modulated corresponding to a motion of said object; wherein the received laser beam is the scattered laser beam; and wherein the method further comprises combining the interferometric transmission signal and the interferometric reflection signal to generate an output signal corresponding to the motion of the object and indicative of a property of the object.

18. A method according to claim 17, wherein the combining comprises
scaling at least one of the interferometric reflection signal and the interferometric transmission signal relative to the corresponding other signal by a predetermined relative scale factor; and
combining the scaled interferometric reflection and transmission signals with one another to obtain the output signal.

19. A method according to claim 18, wherein combining the scaled interferometric reflection and transmission signals with one another comprises subtracting the scaled interferometric reflection and transmission signals from another.

20. A method according to claim 18, wherein the scale factor is a predetermined constant scale factor.

21. A method according to claim 18, further comprising
detecting a noise level of the output signal; and
adaptively controlling the scale factor to reduce the detected noise level.

22. A detection device for detecting a property of an object, the device comprising
a detection laser arrangement adapted to direct a detection laser beam to the object to produce a scattered laser beam modulated corresponding to a motion of said object;
an optical interferometer adapted to receive the scattered laser beam and to produce an interferometric transmission signal and an interferometric reflection signal corresponding to the motion of the object;
signal processing means adapted to generate an output signal from the interferometric transmission signal and the interferometric reflection signal, the output signal being indicative of the property to be detected;
characterised in that the signal processing means is adapted to generate the output signal a ratio of a signal derived from the interferometric transmission signal and a signal derived from the interferometric reflection signal.

23. A detection device according to claim 22, wherein the optical interferometer has a resonance frequency; and wherein the detection device further comprises control means for adjusting the resonance frequency of the optical interferometer in response to a control signal generated from a combination of the interferometric transmission signal and the interferometric reflection signal.

24. A detection device according to claim 22, wherein the detection laser is a continuous-wave laser.

25. A detection device according to claim 22, wherein the ratio of a signal derived from the interferometric transmission signal and a signal derived from the interferometric reflection signal is the ratio of the interferometric transmission signal and the interferometric reflection signal.

26. A detection device according to claim 22, further comprising
an adder circuit for generating a derived reflection signal from the interferometric reflection signal by adding a first offset to the interferometric reflection signal; and
an adder circuit for generating a derived transmission signal from the interferometric transmission signal by adding a second offset to the interferometric transmission signal;
and wherein the ratio is the ratio of the derived transmission signal and the derived reflection signal.

27. A detection device according to claim 26, further comprising means for scaling one of the interferometric reflection signal and the interferometric transmission signal by a respective scale factor.

28. A detection device according to claim 26, wherein the first and second offsets are determined such that the ratio of the derived transmission signal and the derived reflection signal at the working point of the optical interferometer is substantially constant.

29. A detection device according to claim 22, wherein the optical interferometer has a resonance frequency; and wherein the detection device further comprises means for adjusting the resonance frequency of the optical interferometer.

30. An optical interferometer adapted to receive a laser beam and to produce at least one of an interferometric transmission signal and an interferometric reflection signal;
wherein the optical interferometer comprises control means adapted to adjust the resonance frequency of the optical interferometer in response to a control signal;
characterised in that the optical interferometer further comprises signal processing means adapted to generate the control signal from a ratio of a first and a second signal, each being substantially proportional to the intensity of the received laser beam in a working point of the interferometer, by
generating a first derived signal by adding a first offset to the first signal;
generating a second derived signal by adding a second offset to the second signal; and
generating the control signal as a ratio of the first derived signal and the second derived signal.

31. An optical interferometer according to claim 30, further comprising means for scaling one of the first and second signals by a respective scale factor.

32. An optical interferometer according to claim 30, wherein the first and second offsets are determined such that the ratio of the first derived signal and the second derived signal at the working point of the optical interferometer is substantially constant.
